(19) United States
(12) Patent Application Publication
(10) Pub. No.: US 2026/0036260 A1
(43) Pub. Date: Feb. 5, 2026

(54) METHOD FOR OPERATING AND/OR FUELING A COMPRESSED GAS SUPPLY SYSTEM AND ELECTRONIC DEVICE

(71) Applicant: Robert Bosch GmbH, Stuttgart (DE)

(72) Inventors: Jochen Wessner, Esslingen (DE); Martin Katz, Stuttgart (DE); Thomas Breitbach, Weissach Im Tal (DE)

(21) Appl. No.: 19/099,799

(22) PCT Filed: Jul. 4, 2023
(86) PCT No.: PCT/EP2023/068371

§ 371 Date: Jan. 30, 2025

(30) Foreign Application Priority Data
Aug. 3, 2022 (DE) 10 2022 208 066.1

(51) Int. Cl. F17C 7/00; H01M 8/04082; H01M 8/04089; H01M 8/04746; H01M 8/04858

(52) U.S. Cl. CPC F17C 7/00; H01M 8/04104; H01M 8/04201; H01M 8/04753; H01M 8/04917; F17C 2201/0109; F17C 2205/0142; F17C 2205/0323; F17C 2250/03; F17C 2250/0439; F17C 2265/065; F17C 2270/0168; F17C 2270/0184

(57) ABSTRACT

The invention relates to a method of operating and/or fueling a compressed gas supply system (34) having at least two compressed gas tanks (15, 16, 17, 18, 19) connected to an anode path (2) of a fuel cell system (1).

To increase thermal safety during operation and/or fueling of the compressed gas supply system (34), the valve devices (21, 22, 23, 24, 25) assigned to the pressure tanks (15, 16, 17, 18, 19), which comprise a filling path with an actively switchable filling valve and a discharge path with an actively switchable discharge valve for each of the compressed gas tanks (15, 16, 17, 18, 19) are individually actuated via an electronic control unit, which is connected to a sensor device having at least one sensor, which senses a current temperature in the respective valve installation (21, 22, 23, 24, 25).

### BACKGROUND

The invention relates to a method for operating and/or fueling a compressed gas supply system having at least two compressed gas tanks connected to an anode path of a fuel cell system. The invention further relates to an electronic device, preferably an electronic control unit of a vehicle, in particular of a fuel cell vehicle.

A method for initial conditioning of a fuel cell of a fuel cell aggregate for a fuel cell vehicle is known from the German patent application DE 10 2020 206 230 A1, wherein the fuel cell can be controlled by means of an electronic control unit of the fuel cell aggregate, wherein the fuel cell is at least partially or completely initially conditioned with the aid of the electronic control unit. A method for operating a fuel cell system is known from the German patent application DE 10 2020 212 077 A1, in which hydrogen is withdrawn from a hydrogen reservoir and fed via an anode path to a fuel cell stack and in which the hydrogen mass flow rate is predetermined by a hydrogen dosing valve disposed in the anode path, wherein the pressure can be variably adjusted independent of the mass flow rate using a controllable pressure reducer, which is disposed upstream of the hydrogen dosing valve in the anode path, wherein the pressure can be adjusted depending on at least one current condition, in particular depending on the ambient temperature, the timing of the last fueling operation, the fill level in the hydrogen reservoir, the calibrated pressure downstream of the pressure reducer, the pressure in the anode, the pressure in a cathode and/or the conveyed hydrogen mass flow rate. A similar method for operating a fuel cell system is known from the German patent application DE 10 2020 210 300 A1, wherein the hydrogen removed from the compressed gas tank is thermally conditioned using a heat exchanger disposed in the anode path.

### SUMMARY

The object of the invention is to simplify or improve the operation and/or fueling of a compressed gas supply system having at least two compressed gas tanks connected to an anode path of a fuel cell system.

The object is solved by a method of operating and/or fueling a compressed gas supply system having at least two compressed gas tanks that are connected to an anode path of a fuel cell system, in that valve installations assigned to the pressure tanks, which for each of the compressed gas tanks comprise a filling path with an actively switchable filling valve and a discharge path with an actively switchable discharge valve, can be individually activated via an electronic control unit connected to a sensor device, which comprises at least one sensor that senses a current temperature in the respective valve installation. For example, the method is used in fuel cell systems that comprise hydrogen-based fuel cells in which hydrogen is converted into electrical energy using oxygen. The electrical energy provided in this way is used for drive power in a mobile application, for example in an electric motor of a vehicle. However, the claimed method may also be used in internal combustion engine systems in which hydrogen is used for combustion. Each of the compressed gas tanks can be individually filled and emptied with the actively switchable valves. This provides tremendous benefits, on the one hand, when filling the compressed gas tanks in the compressed gas supply system at a corresponding fueling station, for example a hydrogen filling station. On the other hand, the compressed gas contained in the compressed gas tanks, in particular hydrogen, can be transported between the individual compressed gas tanks as needed during operation of the compressed gas supply system, as well as when a motor vehicle equipped with the compressed gas supply system is at a standstill. This can save time during refueling. Moreover, individual compressed gas tanks may be filled with more compressed gas than in conventional compressed gas supply systems if needed. Furthermore, individual compressed gas tanks may also be operated under a minimum limit pressure as needed because individual compressed gas tanks may be quickly and easily disconnected and connected to the compressed gas system by closing the actively switchable valves for a period of time. The sensor device, which advantageously comprises a plurality of sensors, is able to sense more than just the temperature in the valve installations assigned to the individual compressed gas tanks. Advantageously, the sensor device is also able to sense further fluid operating data in the respective valve installation, such as a pressure at a branch in the valve installation and/or a mass flow rate through the respective valve installation during filling or emptying of the compressed gas tank. The controller is equipped with a suitable software product to process the signals from the sensors of the sensor device and to individually activate the switching valves, i.e. the actively switchable filling valve and the actively switchable discharge valve.

One exemplary embodiment of the method is characterized in that that the electronic control unit is equipped with a data record product that contains reference fluid data and/or limit data, with the aid of which the valve installations are actuated depending on the sensed current temperatures in the valve installations during a fueling operation and/or during operation of the compressed gas supply system, so that the compressed gas tank temperatures also sensed in the compressed gas tanks are kept below a first limit temperature. The reference fluid data and/or limit data comprises at least one limit temperature, preferably a plurality of different limit temperatures, a temperature characteristic curve, and/or a temperature characteristic diagram. Compressed gas tank temperatures are sensed in all compressed gas tanks using suitable sensors. Advantageously, the temperature of hydrogen in the respective filling paths and discharged paths can be sensed via the temperature detection in the valve installations. Thus, in combination with the compressed gas tank temperatures which are also sensed, highly effective temperature control and/or temperature regulation is enabled both during fueling and during operation of the compressed gas supply system.

Another exemplary embodiment of the method is characterized in that that the electronic control unit is provided with a data record product, the reference fluid data and/or limit data, with the aid of which the valve installations are activated depending on the sensed current temperatures in the valve installations during a fueling operation and/or during operation of the compressed gas supply system, such that an increase of an individual compressed gas tank temperature in one of the compressed gas tanks is limited via the activation of the respective valve installation as soon as a second limit temperature is reached in the compressed gas tank in question. The English term derating may also be used for the limitation of the individual compressed gas tank temperature via activation of the respective valve installation. Derating means, among other things, reducing, lowering, or downregulating. By using the two limit temperatures, temperature control or regulation may be further improved during operation as well as during fueling of the compressed gas supply system.

Another exemplary embodiment of the method is characterized in that the filling path of a compressed gas tank with a sensed compressed gas tank temperature below the first limit value is released via the filling valve in the respective valve installation to meet a predetermined safety requirement. For example, the safety requirement comprises achieving a legally required safe level in operation of the compressed gas supply system. When the predetermined safe level has been reached, the filling path of the compressed gas tank is blocked once again.

Another exemplary embodiment of the method is characterized in that at least one discharge path of a compressed gas tank is released via the discharge valve in the respective valve installation to selectively dissipate heat from the compressed gas tank which was introduced from the outside into the respective compressed gas tank. This may further increase safety in operation and/or fueling of the compressed gas supply system. Once a sufficient amount of heat is dissipated, the discharge path of the respective compressed gas tank is blocked once again.

Another exemplary embodiment of the method is characterized in that the filling paths and/or discharge paths of the valve installations are specifically controlled via the electronic control unit to regulate the timing of the compressed gas tank temperatures in the compressed gas tanks. A correspondingly optimized removal strategy from the individual compressed gas tanks allows the temperature in the compressed gas tanks to be limited as needed in a simple manner. In this way, pre-determined safety requirements can be easily met.

Another exemplary embodiment of the method is characterized in that the compressed gas tanks are filled in a cascaded manner via a check valve in the filling path of the associated valve installation after the filling valve is activated if the compressed gas tanks have different internal tank pressures during fueling. The compressed gas tank in question is advantageously not fueled until the internal tank pressure in the compressed gas tank is exceeded during fueling. This can effectively increase fueling efficiency.

A further exemplary embodiment of the method is characterized in that compressed gas tanks having different storage volumes are not fueled at the same time via the respective associated filling paths but at times offset from one another, wherein filling paths of compressed gas tanks having a larger storage volume are released via the electronic control unit before filling paths of compressed gas tanks having a smaller storage volume. For example, if there are two compressed gas tanks of different sizes, the larger compressed gas tank is filled first. If there are a plurality of larger compressed gas tanks, these are advantageously filled in a cascaded manner before smaller compressed gas tanks are filled. During a fueling operation, if a compressed gas tank temperature in a compressed gas tank exceeds a limit temperature, the filling operation of the respective compressed gas tank may be easily interrupted, while filling of other compressed gas tanks may easily be continued.

Another exemplary embodiment of the method is characterized in that compressed gas is purposefully displaced between the compressed gas tanks via the associated valve installations to perform an internal balancing of the compressed gas supply system. This is also advantageously controlled via the electronic control unit. Displacing the compressed gas between the compressed gas tanks enables an intelligent operating strategy and/or fueling strategy via the electronic control unit, for example, using artificial intelligence. The filling process for a compressed gas tank in question may be purposefully slowed before a limit temperature is reached, for example.

The invention optionally also relates to a compressed gas supply system having at least two compressed gas tanks connected to an anode path of a fuel cell system, wherein each of the compressed gas tanks is associated with a valve installation having a filling path in which an actively switchable filling valve is disposed and having a discharge path in which an actively switchable discharge valve is disposed. In this case, higher manufacturing costs due to the required paths and actively switchable valves in the valve installations are known and accepted.

One exemplary embodiment of the compressed gas supply system is characterized in that the filling path and discharge path in the valve installation between a tank interior of the respective compressed gas tank and a branch are connected in parallel via a fluidic connection. This allows each of the compressed gas tanks to be individually filled via the filling path with the actively switchable filling valve in a simple manner. Each of the compressed gas tanks can be individually discharged via the discharge path with the switchable discharge valve. Thus, the compressed gas system can operate more effectively both when fueling and during operation under extreme environmental conditions, particularly environmental temperatures, than conventional compressed gas systems.

A further exemplary embodiment of the compressed gas supply system is characterized in that the filling valve is disposed in the filling path between the branch and a check valve that blocks toward the fill valve, wherein a check valve is disposed in the discharge path between the discharge valve and the branch that blocks toward the discharge valve. This prevents malfunctions during operation of the compressed gas supply system.

Another exemplary embodiment of the compressed gas supply system is characterized in that the valve installation is integrated with the filling path, the filling valve, the discharge path, the discharge valve, and the branch into a valve block attached to the respective compressed gas tank. In addition to the specified components, the valve block also comprises other components, some of which are legally required, such as check valves, filters, sensors, and particularly advantageously a pressure limiter. The valve block is preferably attached to one end of the respective compressed gas tank. For manufacturing reasons, the valve block is preferably manufactured independently of the compressed gas tank. For example, the valve block is threaded into an opening of the compressed gas tank. A simple sealing ring, for example an O-ring, may be used for sealing between the valve block and the compressed gas tank. By integrating the actively switchable valves into the valve block, a combination of the claimed valve apparatus with conventional compressed gas tanks is easily enabled.

Another exemplary embodiment of the compressed gas supply system is characterized in that the filling valve and the discharge valve are embodied as electromagnetically actuatable 2/2-way valves. The 2/2-way valves comprise a closed position and an open position in which the respective path is released. Both valves are preferably pre-tensioned to their respective closed position, in which the passage of fluid through the respective path is interrupted. The valves can be opened by electromagnetic actuation. This increases safety during operation of the compressed gas supply system.

Another exemplary embodiment of the compressed gas supply system is characterized in that the filling valve and the discharge valve are connected to an electronic control unit that is connected to a sensor device comprising at least one sensor that senses fluid operating data, such as a pressure, temperature, and/or mass flow rate at the branch. This enables convenient and simple control of the temperature of a pressure and/or a fill level in the respective compressed gas tank. A data set is advantageously stored in the electronic control unit that contains corresponding reference data and/or limit data for the pressure, temperature and/or mass flow rate.

In a method of operating a compressed gas supply system as previously described, the object set forth above is alternatively or additionally solved by individually controlling the filling valve and the discharge valve with the electronic control unit depending on the fluid operating data sensed with the sensor device. This allows the individual compressed gas tanks to be individually filled and emptied as needed. This results in advantages in fueling the compressed gas tanks of the compressed gas supply system. In addition, there are significant advantages in the operation of the compressed gas supply system.

One exemplary embodiment of the method is characterized in that the filling valve and the discharge valve are individually activated with the electronic control unit such that the compressed gas tanks are filled and/or emptied in a non-uniform manner. This is particularly advantageous when the compressed gas supply system contains compressed gas tanks of different sizes and/or also contains compressed gas tanks that are exposed to different ambient conditions, in particular ambient temperatures, when installed. This may be due, for example, to the fact that individual compressed gas tanks are arranged further toward the outside in or on the motor vehicle, which can lead to these compressed gas tanks heating faster than compressed gas tanks arranged further toward the inside of the vehicle in strong sunlight.

The invention further relates to an electronic device, preferably an electronic control unit of a vehicle, in particular of a fuel cell vehicle, adapted to carry out a method as described above. The electronic device can be used to individually control the valve installations of the individual compressed gas tanks. Thus, convenient control of the level, temperature, and/or pressure in the individual compressed gas tanks of the compressed gas supply system is enabled.

The invention also relates, where applicable, to a valve installation, in particular a valve block, a filling valve, a discharge valve, a sensor device, a sensor, a check valve, and/or a compressed gas tank for a compressed gas supply system as described above. The mentioned parts can be procured separately.

### BRIEF DESCRIPTION OF THE DRAWINGS

Further advantages, features, and details of the invention arise from the following description, in which exemplary embodiments are described in detail with reference to the drawings.

Shown are:

FIG. 1 a schematic representation of a compressed gas supply system having a total of five compressed gas tanks fueled at a hydrogen filling station, wherein each of the compressed gas tanks has a valve installation comprising a filling path with an actively switchable filling valve and a discharge path with an actively switchable discharge valve; and

FIG. 2 one of the valve installations of FIG. 1 in the form of a fluid schematic diagram.

### DETAILED DESCRIPTION

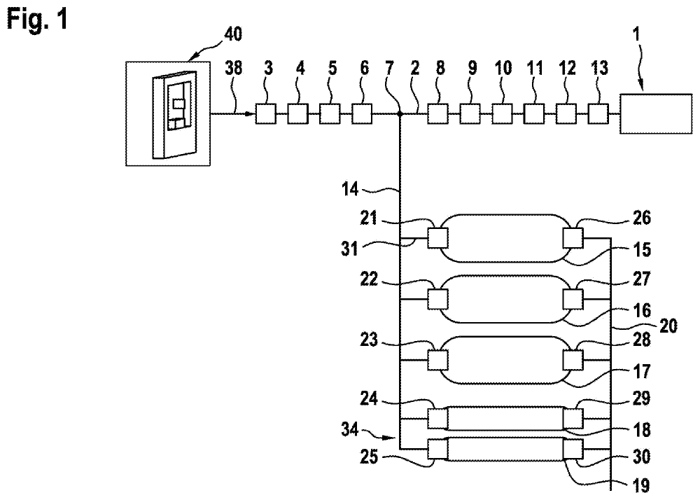

A hydrogen filling station 40 is indicated on the schematic diagram in FIG. 1. An arrow 38 indicates that a motor vehicle not shown in more detail with a fuel cell system 1 is being fueled with hydrogen at the hydrogen filling station 40.

The fuel cell system 1 comprises an unspecified fuel cell stack with fuel cells each comprising an anode that is supplied with hydrogen via anode path 2. The construction and function of such fuel cell systems are known.

A check valve 3, a filter 4, a pressure sensor 5, a temperature sensor 6, a temperature sensor 8, a further pressure sensor 9, a further filter 10, a pressure reducer 11, a further filter 12 and a check valve 13 are arranged in the anode path 2. A fluid branch 7 is provided between the temperature sensor 6 and the temperature sensor 8. At the fluid branch 7, a manifold 14 opens into the anode path 2.

A total of five compressed gas tanks 15, 16, 17, 18 and 19 of a compressed gas supply system 34 are connected to the manifold 14 via a fluidic connection. The compressed gas tanks 15 to 19 are in some cases different in size. Compressed gas tanks 15 to 17 are approximately the same size, but larger than the two compressed gas tanks 18, 19, which are also the same size.

Compressed gas tanks 15 to 19 are each equipped with a valve installation 21 to 25 at their left ends in FIG. 1. At their right ends in FIG. 1, the compressed gas tanks 15 to 19 are each equipped with a valve installation 26 to 30. The compressed gas tanks 15 to 19 are connected to a manifold 20 via the valve installations 26 to 30. For example, the manifold 20 serves to manually empty the compressed gas tanks 15 to 19. In this case, the valve installations 26 to 30 are designed as tank drain valves.

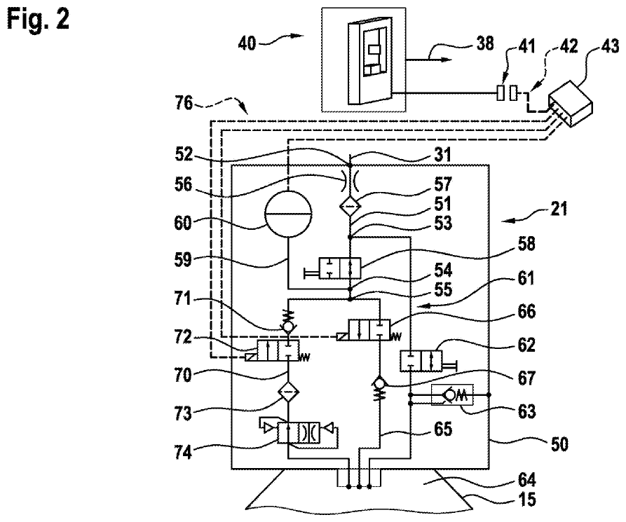

Valve installations 21 to 25 all have the same design and will be described in detail below with reference to FIG. 2 by means of the valve installation 21 at the left end of the compressed gas tank 15 in FIG. 1. The valve installation 21 is connected to the manifold 14 via a connecting line or attachment line 31. Thus, in FIG. 2, a tank interior of the compressed gas tank 15 designated as 64 can be connected to the manifold 14 and the anode path 2 via the valve installation 21.

The valve installation 21 is integrated into a valve block 50, which, as indicated in FIG. 2, is attached to a top end of the compressed gas tank 15 in FIG. 2 which, e.g., is embodied as a gas cylinder.

In FIG. 2 above, the hydrogen filling station 40 is schematically depicted with the tank path 38, symbolically indicated by an arrow. The hydrogen filling station 40 can be connected to an electronic control unit 43 via an infrared interface 41 and a control line 42. The electronic control unit 43 in the fuel cell vehicle equipped with the fuel cell system 1 shown in FIG. 1 is assigned to the compressed gas supply system 34 and the fuel cell system 1.

The hydrogen filling station 40 is indicated in FIG. 2 above. A top end of the compressed gas tank 15, embodied as a gas cylinder in FIG. 2, is indicated in FIG. 2 below. A tank interior 64 of compressed gas tank 15 is connected to an emptying path 61, a filling path 65, and a discharge path 70. The three paths 61, 65 and 70 extend through the valve block 50.

In FIG. 2 above, the connecting line 31 is connected to the valve block 50 at a connection point 52. A connecting line 51 extends from the connection point 52 to a fluid branch 53 in the valve block 50. The connecting line 51 is preferably embodied as a connection channel in the valve block 50. For the sake of simplicity, all fluidic connections are hereinafter referred to as lines. However, in the valve block 50, all lines are preferably embodied as bores.

An optional hydraulic resistance 56 in the form of a throttle is provided in the connecting line 51. A filter 57 is disposed between hydraulic resistance 56 and the branch 53. The emptying path 61, which opens into the tank interior 64, exits from the branch 53. Two valves 62 and 63 are connected in series in the emptying path 61. The valve 62 is a manual emptying valve or drain valve. The compressed gas tank 15 may be manually emptied via the valve 62 as needed, for example, during decommissioning at the end of its service life.

The valve 63 is a pressure relief valve that can be thermally activated. The tank interior 64 may be discharged via the valve 63. A manually actuatable closing valve 58 is disposed between the branch 53 and a branch 54. The manually actuatable closing valve 58 serves to securely close the compressed gas tank 15, for example during a repair.

A sensor line 59 exits from the branch 54, through which operational data, such as pressure, temperature, and/or a fluid mass flow rate, is sensed at the branch 54 in the valve block 50 using a sensor device 60 while the pressure supply system is in operation The connecting line 51 starting from the branch 52 opens in a branch 55, from which the filling path 65 starts and at which the discharge path 70 ends.

A filling valve 66 and a check valve 67 are connected in series in the filling path 65. Check valve 67 opens towards the tank interior 64 and closes towards the filling valve 66. The filling path 65 runs from the branch 55 in parallel to discharge path 70.

A check valve 71, a discharge valve 72, a filter 73, and a flow restrictor 74 are connected in series in the discharge path 70. The check valve 71 shuts off the flow towards the discharge valve 72 and opens it towards the branch 55. The flow restrictor 74 serves to limit leakage in the event of an undesired line break.

The filler valve 66 and discharge valve 72 are embodied as 2/2-way valves having an open position and a closed position. The two valves 66 and 72 are electromagnetically actuated and are connected to the electronic control unit 43, which is used to control them. Both valves 66 and 72 are pre-tensioned in their respective closed position, as indicated by spring symbols. The sensor device 60 is also connected to the electronic control unit 43 for sensing or in order to control it. In FIG. 2, control lines or signal lines or sensor lines 76 are indicated as dashed lines.

The electronic control unit 43 is equipped with software that processes the signals of the sensors sensed with the sensor device 60 when the compressed gas system 34 is in operation. For example, the sensors of the sensor device 60 are used to sense the temperature, pressure, mass flow, flow direction, and optionally other measured variables at the branch 54 in the valve block 50.

The electronic control unit 43 is used to individually actuate the compressed gas tanks 15-19 to fill and/or drain compressed gas tanks 15-19 in a non-uniform manner. To this end, the filling valve 66 and the discharge valve 72 are actively actuated via the electronic control unit 43. In this manner, individual compressed gas tanks 15-19 may be drained at a permissible operating system limit pressure while at least one of the compressed gas tanks 15-19 remains pressurized with at least the allowable operating system limit pressure. Thus, a defined amount of compressed gas, particularly hydrogen, may be maintained in the compressed gas tank discharged at the allowed operating system limit pressure, which may then be used to condition the fuel cell system 1 when the system is started.

Actively releasing the filling path 65 using the electronic control unit 43 via the filling valve 66 allows the compressed gas supply system 34 to operate with fuel cell system 1 even in the case of different internal tank pressures. The switching valves 66 and 72 are individually activated depending on the operating mode of a vehicle equipped with fuel cell system 1 and compressed gas system 34, for example in the operating modes of travel, parking, refueling.

Through targeted regulation or control of the pressures and/or temperatures of the individual compressed gas tanks 15 to 19, it is advantageously possible to reduce the pressure below the system-specific limit pressure. This lowering can be particularly advantageous at system start-up when a compressed gas tank with low pressure is pre-filled, i.e. when the tank is flooded with hydrogen or conditioned for operation with hydrogen. This conditioning can be carried out to a very low residual pressure. This increases the range of the system.

The claimed method enables a targeted, timed regulation or control of the compressed gas tank temperatures by means of an optimized removal strategy from the individual compressed gas tanks. Thus, the compressed gas tank temperature in the individual compressed gas tanks may be limited to increase operational safety. It is possible to react promptly to an increase in the compressed gas tank temperatures via the actively switchable valves.

In the event that the compressed gas tanks have different pressures during fueling, check valve 67 in filling path 65 automatically ensures cascaded fueling after switching the filling valve 66. The compressed gas tank in question is not filled until the current pressure in the compressed gas tank in question is exceeded during fueling.

1. A method of operating and/or fueling a compressed gas supply system (34) having at least two compressed gas tanks (15, 16, 17, 18, 19), which are connected to an anode path (2) of a fuel cell system (1), wherein valve installations (21, 22, 23, 24, 25) assigned to the pressure tanks (15, 16, 17, 18, 19), which comprise a filling path (65) for each of the compressed gas tanks (15, 16, 17, 18, 19) having an actively switchable filling valve (66) and a discharge path (70) having an actively switchable discharge valve (72), are individually activated via an electronic control unit (43), which is connected to a sensor device (60) comprising at least one sensor, which senses a current temperature in the respective valve installation (21, 22, 23, 24, 25).

2. A method according to claim 1, wherein the electronic control unit (43) is provided with a data record product containing fluid reference data and/or limit data, with the help of which the valve devices (21, 22, 23, 24, 25), are activated depending on the sensed current temperatures in the valve installations (21, 22, 23, 24, 25) during a fueling operation and/or during operation of the compressed gas supply system (34), so that compressed gas tank temperatures which are also sensed in the compressed gas tanks (15, 16, 17, 18, 19) are kept below a first limit temperature.

3. A method according to claim 2, wherein the electronic control unit (43) is provided with a data record product containing fluid reference data and/or limit data, with the help of which the valve devices (21, 22, 23, 24, 25) are activated depending on the sensed current temperatures in the valve devices (21, 22, 23, 24, 25) during a fueling operation and/or during operation of the compressed gas supply system (34), so that an increase of an individual compressed gas tank temperature in one of the compressed gas tanks (15, 16, 17, 18, 19) is limited by activation of the respective valve installation (21, 22, 23, 24, 25), as soon as a second limit temperature is reached in the compressed gas tank (15, 16, 17, 18, 19) in question.

4. A method according to claim 2, wherein the filling path (65) of a compressed gas tank (15, 16, 171, 181, 19) for which the sensed compressed gas tank temperature is below the first limit value is released via the filling valve (66) in the respective valve installation (21, 22, 23, 24, 25) to meet a predetermined safety requirement.

5. A method according to claim 2, wherein at least one discharge path (70) of a compressed gas tank (15, 16, 17, 18, 19) is released via the discharge valve (72) in the respective valve installation (21, 22, 23, 24, 25) to dissipate heat which enters the respective compressed gas tank (15, 16, 17, 18, 19) from the outside from the compressed gas tank (15, 16, 17, 18, 19) in a targeted manner.

6. A method according to claim 1, wherein the filling paths (65) and/or the discharge paths (70) of the valve installations (21, 22, 23, 24, 25) are controlled in a targeted manner via the electronic control unit (43) to regulate the timing of the compressed gas tank temperatures in the compressed gas tanks (15, 16, 17, 18, 19).

7. A method according to claim 1, wherein the compressed gas tanks (15, 16, 17, 18, 19) are refueled in a cascaded manner via a check valve (67) in the filling path (65) of the associated valve installation (21, 22, 23, 24, 25) after actuation of the filler valve (66) if the compressed gas tanks (15, 16, 17, 18, 19) have different interior tank pressures during fueling.

8. A method according to claim 1, wherein compressed gas tanks (15, 16, 17, 18, 19) having different sized storage volumes are not fueled simultaneously via the respective associated filling paths (65) but at times offset from one another, wherein filling paths (65) of compressed gas tanks (26, 27, 28) having a larger storage volume are released before filling paths (65) of compressed gas tanks (29, 30) having a smaller storage volume via the electronic control unit (43).

9. A method according to claim 1, wherein compressed gas is moved between the compressed gas tanks (15, 16, 17, 18, 19) in a targeted manner via the associated valve installations (21, 22, 23, 24, 25) to perform an internal balancing of the compressed gas supply system (34).

10. An electronic control unit (43) of a vehicle, which is connected to a sensor device (60) comprising at least one sensor, which senses a current temperature in the respective valve installation (21, 22, 23, 24, 25), the electronic control unit configured to operate and/or fuel a compressed gas supply system (34) having at least two compressed gas tanks (15, 16, 17, 18, 19), which are connected to an anode path (2) of a fuel cell system (1), by individually activating valve installations (21, 22, 23, 24, 25) assigned to the pressure tanks (15, 16, 17, 18, 19), which comprise a filling path (65) for each of the compressed gas tanks (15, 16, 17, 18, 19) having an actively switchable filling valve (66) and a discharge path (70) having an actively switchable discharge valve (72).
